(19) United States
(12) Patent Application Publication
(10) Pub. No.: US 2017/0107946 A1
(43) Pub. Date: Apr. 20, 2017

(54) ROCKET ENGINE WITH A VERSATILE IGNITION TORCH

(71) Applicant: AIRBUS SAFRAN LAUNCHERS SAS, lssy-Les-Moulineaux (FR)

(72) Inventors: Jean-Luc LE CRAS, Saint-Marcel (FR); Laurent GOMET, Blaru (FR); Louise LESAUNIER, Heubecourt-Haricourt (FR); Jean-Claude BOURDAIS, Panilleuse (FR); Carlos CRUZ, Gaillon (FR)

(73) Assignee: AIRBUS SAFRAN LAUNCHERS SAS, lssy-Les-Moulineaux (FR)

(21) Appl. No.: 15/292,227

(22) Filed: Oct. 13, 2016

(30) Foreign Application Priority Data
Oct. 14, 2015 (FR) 15 59765

(51) Int. Cl. F02K 9/95; F02K 9/52; F02K 9/58

(52) U.S. Cl. CPC F02K 9/95; F02K 9/58; F02K 9/52; F05D 2220/80

(57) ABSTRACT

A rocket engine having a rocket engine combustion chamber (116) and an ignition torch (10).

The rocket engine combustion chamber (116) is a main combustion chamber, or a combustion chamber of a gas generator, or a combustion chamber of a preburner of the rocket engine.

The ignition torch (10) comprises a body (20) in which a combustion chamber (21) is arranged and an ejection tube (40) for discharging combustion gas leaving the combustion chamber.

The body (20) of the torch is configured to enable the combustion chamber to be fed with fuel and oxidizer via respective fuel and oxidizer feed ducts.

The ignition torch (10) also has an oxidizer reinjection duct (60) configured to enable oxidizer to be injected substantially at the outlet of the ejection tube (40).

### FIELD OF THE INVENTION

The invention relates to a rocket engine having a rocket engine combustion chamber and an ignition torch for initiating combustion in the rocket engine combustion chamber.

### STATE OF THE PRIOR ART

Rocket engines generally operate by causing two propellants, often oxygen and hydrogen, to meet and combust within a combustion chamber: the burnt gas produced by such combustion escapes at very high speed from the combustion chamber, usually via a nozzle or a diverging portion, thereby producing thrust in reaction that propels the rocket.

Once such combustion has started, it is self-sustaining so long as propellant feed is maintained. Nevertheless, starting such an engine, that uses large volumes of propellant, requires a large quantity of energy in order to initiate combustion, a quantity of energy that a mere spark plug cannot deliver. Thus, rocket engines are fitted with ignition torches that serve to initiate the combustion reaction in the combustion chamber of the engine so as to enable the engine to be started.

Such ignition torches can be used in particular either for launching the rocket (or space vehicle), or during various stages of flight.

Ignition torches include pyrotechnic ignition torches and internal combustion chamber ignition torches. Unlike pyrotechnic ignition torches, internal combustion chamber ignition torches can be reused, and thus make it possible to restart the engine in flight, where appropriate.

Such an ignition torch mainly consists in a small combustion chamber fed with propellant and provided with a spark plug capable of igniting the small quantity of propellant introduced into the chamber: the combustion gas as generated in this way is then ejected into the combustion chamber of the engine and it is sufficiently energetic to initiate combustion therein and start the engine.

Nevertheless, depending on the mode of operation desired for the engine (or “mode of operation of the engine”), the performance expected of the ignition torch varies.

Different modes of operation of the engine differ from one another in particular in the temperature of the gas produced by the ignition torch and injected into the engine in order to enable it to start, or indeed by the flow rate of gas at the outlet of the ignition torch. The modes of operation of the engine are generally characterized by their “mixture ratio” RM, i.e. the (mass) ratio of the relative quantities of oxidizer and fuel injected into the torch. When the mixture ratio RM is relatively high, i.e. greater than 1.5, the temperature of the gas produced by the ignition torch is generally very high, thus often making it difficult to provide the ignition torch with sufficient mechanical strength to be capable of performing a sufficient number of engine starts.

In particular there exist the following:

low pressure ignition torches that are fed with propellants pressurized at the low pressure of the tanks: unfortunately, these become deficient whenever there is any opposing pressure becomes present in the combustion chamber, i.e. in particular on the ground or at low altitude. They also give off relatively little energy and can thus potentially fail to start the engine, requiring several attempts before the engine actually starts; and

high pressure ignition torches, in which the propellants are stored in tanks that are pressurized at high pressure. Nevertheless, such tanks are heavy and therefore very expensive.

Those various torches therefore either raise problems of reliability, or else problems of complexity and consequently of price, of weight, and of size.

In particular, none of those torches provides a solution that is simple and reliable for making an ignition torch that can be used at a high mixture ratio.

### SUMMARY OF THE INVENTION

Thus, the object of the invention is to provide a rocket engine comprising a rocket engine combustion chamber and an ignition torch for initiating combustion in the rocket engine combustion chamber; the rocket engine combustion chamber being a main combustion chamber of the rocket engine, or a combustion chamber of a gas generator of the rocket engine, or a combustion chamber of a preburner of the rocket engine, the ignition torch comprising a body in which a combustion chamber is arranged, and an ejection tube for discharging the combustion gas leaving the combustion chamber, the ejection tube having a first end whereby it is connected to the body and a second end arranged in the rocket engine combustion chamber, and the body being configured to allow the combustion chamber to be fed with fuel and oxidizer respectively via a fuel feed duct and an oxidizer feed duct;

which ignition torch is reliable, relatively simple, and capable of being used in particular with a high mixture ratio, giving rise in particular to very high temperatures for the gas ejected by the ignition torch.

This object is achieved by the fact that the ignition torch further comprises an oxygen reinjection duct configured to enable oxygen to be injected substantially at the outlet of the ejection tube.

In a rocket engine, the term “combustion chamber of a preburner” is used to designate a combustion chamber in which fuel is burnt in order to produce hot gas enabling the turbopumps of the engine to be driven prior to being subsequently reinjected into the main combustion chamber of the rocket engine: a chamber of a preburner is characteristic of rocket engines having a staged combustion cycle.

The second injection of oxidizer (or “reinjection” of oxidizer) performed specifically at the outlet of the ejection tube enables the ignition torch to produce combustion of the fuel in two stages:

Firstly it enables first or main combustion to take place in the combustion chamber, which is fed by the feed channels with fuel and oxidizer.

However, by injecting oxidizer at the outlet of the ejection tube by means of the oxidizer reinjection duct, the ignition torch also enables second combustion to take place at the outlet of the ejection tube, this second combustion serving to raise the temperature of the gas ejected by the ejection tube of the torch to a very great extent.

By way of example, it is thus possible to feed the combustion chamber with fuel and oxidizer in such a manner that the temperature in the chamber is about 500 K to 600 K at the end of first combustion; and thereafter to inject a quantity of oxidizer at the outlet of the ejection tube that, at the end of second combustion, enables the temperature of the outlet gas to rise to 3600 K.

Therefore, and advantageously, the structure of the ignition torch enables the body of the torch to be maintained at a temperature that is relatively low so that it is not stressed excessively either thermally or mechanically; conversely, the second combustion that takes place at the outlet of the ejection tube enables the temperature of the gas ejected by the torch to be raised considerably, thereby greatly increasing the capacity of the torch for igniting propellants in the combustion chamber and for starting the rocket engine. Advantageously, the ignition torch of the invention can thus operate at a mixture ratio that is high and can do that without the torch being damaged, since only the end of the ejection tube is raised to very high temperature.

Preferably, the flow rates of fuel and oxidizer in the feed channels of the ignition torch are selected to that the first combustion takes place at a temperature that is relatively low, in particular in order to avoid exposing the body of the ignition torch to temperatures that are too high and that might damage it.

The rocket engine of the invention is particularly advantageous when the rocket engine combustion chamber is of relatively large dimensions.

Specifically, in a preferred embodiment, the minimum distance between each wall of the rocket engine combustion chamber and the second end of the ejection tube is greater than kD, where D is the inside diameter at the outlet of the ejection tube, and k is a coefficient equal to 3, or indeed equal to 6, or even equal to 10.

Under such conditions, because the distance between the second end of the ejection tube and the walls of the rocket engine combustion chamber is quite large (i.e. this distance is greater than kD), even if the temperature in the proximity of the second end of the ejection tube becomes very high, that does not cause the temperature of the wall of the rocket engine combustion chamber to rise in a manner that might damage it.

Consequently, the rocket engine can be used with, for the ignition torch, a high mixture ratio.

It should also be understood that the “distance between the end of the ejection tube and the walls of the chamber” relates essentially to the walls of the chamber situated at its sides level with the end of the ejection tube, i.e. situated in the vicinity of a plane perpendicular to the axis of the ejection tube and containing the end of the tube; conversely, the distance between the end of the ejection tube and the walls of the chamber does not relate to the rear walls of the chamber, situated on a rear side of the ejection tube, i.e. next to the body of the torch. Indeed, the flame of the torch is not directed in that direction and thus the flame does not lead directly to raising the temperature of these rear walls.

The mixture ratio is defined relative to the stochiometric proportions of the two propellants being consumed. Consider the situation in which the reaction between the two propellants that takes place in the torch combustion chamber has the following form:

aA+bB→cC+dD+ . . .

in which expression A and B represent respectively the oxidizer and the fuel, a and b represent their respective proportions, C, D, etc. represent the components produced by the combustion, such as water, carbon dioxide gas, etc., and c, d, etc. are the respective proportions of those components.

The stochiometric mixture ratio RM_{S} is defined as being equal to the ratio:

RM_{S}=a/b

Now consider arbitrary reaction conditions in which the propellants are caused to react in relative quantities x and y, the following reaction is made to take place:

xA+yB

Under such conditions, the normalized mixture ratio RM_{N} is defined as follows:

RM_{N}=(x/y)/RM_{S}

Advantageously, the configuration of the rocket engine of the invention makes it possible to operate the ignition torch with a high normalized mixture ratio RM_{N}. Thus, in an embodiment, the rocket engine is configured so that the ignition torch can operate with a normalized mixture ratio (RM_{N}) greater than 5, or possibly greater than 10.

In a particularly advantageous embodiment, the rocket engine may thus be configured both so that the ignition torch can operate at a low normalized mixture ratio (i.e. RM_{N}<0.5, or even RM_{N}<0.25, or indeed RM_{N}<0.1), and also so that the ignition torch can be operated with a high normalized mixture ratio (i.e. RM_{N}>5, or even RM_{N}>10).

In an embodiment, the rocket engine may be configured so that the ignition torch can be operated at any normalized mixture ratio RM_{N} lying between a low normalized mixture ratio and a high normalized mixture ratio, e.g. for any mixture ratio RM_{N} lying in the range 0.5 to 5, or indeed 0.1 to 10.

In order to enable the ignition torch to be operated with a high mixture ratio, in an embodiment, the rocket engine has an electronic control unit configured to control valves for delivering propellants into the ignition torch, and the electronic control unit is configured to be capable of operating the ignition torch with a high normalized mixture ratio RM_{N}, i.e. a ratio greater than 5 or even greater than 10.

The ignition torch may be made in various ways.

In one embodiment, the fuel feed duct and the oxidizer feed duct convey the fuel and the oxidizer respectively to a premixing chamber, which in turn feeds the combustion chamber with fuel and oxidizer.

In another embodiment, the fuel and the oxidizer are conveyed separately, respectively by the fuel feed duct and by the oxidizer feed duct all the way to the combustion chamber.

In an embodiment, the body is made as an integrally formed single piece. The ejection tube may optionally also be fabricated in the same piece as the integrally formed body. By way of example, the ignition torch may be fabricated by an additive method of the 3D printing type.

The ignition torch may optionally be designed to be capable of being used at a plurality of operating points (a plurality of mixture ratios).

In order to vary the mixture ratio, it is possible for example to make provision for the torch to enable the fuel and/or oxidizer and/or oxidizer reinjection flow rate(s) to be regulated continuously.

For this purpose, in an embodiment, the ignition torch comprises a fuel feed regulator valve and/or an oxidizer feed regulator valve for feeding the combustion chamber and/or an oxidizer reinjection regulator valve, which valve(s) is/are adapted to regulate respectively fuel feed to the combustion chamber, oxidizer feed to the combustion chamber, and/or an oxidizer injection flow into the oxidizer reinjection duct.

The above-mentioned valves make it possible to vary the mixture ratio, possibly in real time while in flight, and thus to vary the flow rate and the temperature of the gas ejected by the ignition torch. The valves are naturally controlled by appropriate control means, e.g an electronic control unit (ECU).

In order to act on the fuel or oxidizer flow rates, and/or on the oxidizer reinjection rate, instead of using one or more regulator valves, it is possible to use one or more plates with calibrated flow sections. Such a plate is a part that is normally substantially flat and that is pierced by one or more passages; the flow sections of these passages are determined accurately so that the rate at which fluid passes through the plate is known in advance as a function of the pressure conditions upstream and downstream of the plate.

Advantageously, the use of one or more plates controlling the fuel or oxidizer feed rates and/or the reinjection of oxidizer can act simultaneously to adjust the mixture ratio and control the cooling of the ejection tube.

Thus, in an embodiment, the ignition torch further comprises a fuel feed plate of calibrated flow section arranged in the fuel feed duct, and/or an oxidizer feed plate of calibrated flow section arranged in the oxidizer feed duct, and/or an oxidizer reinjection plate of calibrated section arranged in the oxidizer reinjection duct.

In an embodiment, at least one of the plates is removable. This enables the operation and the performance of the ignition torch to be modified merely by replacing the plate(s) in question with another plate having a different flow section.

In an embodiment, the oxidizer feed plate and the oxidizer reinjection plate form a single plate. This makes it possible to simplify the structure of the ignition torch.

A considerable advantage of the ignition torch of the invention is that its structure enables the temperature reached by the body of the ignition torch to be reduced because of the double combustion as mentioned above.

That said, additional provisions may be adopted in order to further reduce the temperature reached by the body and the ejection tube of the ignition torch.

Thus, in an embodiment, the oxidizer reinjection duct is arranged at least in part in the thickness of a wall of the ejection tube.

The oxidizer reinjection duct thus serves as a cooling duct for the ejection tube. In particular, a portion of the oxidizer reinjection duct may be arranged along the ejection tube, i.e. at a constant distance therefrom. By way of example, it may be separated from the internal duct of the ejection tube by a wall of constant thickness.

Preferably, the oxidizer reinjection duct is made to a large extent within the wall thickness of the ejection tube; for example, it may extend helically around the tube, for one or more turns.

The body of the torch may be cooled by fuel and oxidizer flowing within the wall of the torch body.

Provision may also be made for the fuel feed duct and/or the oxidizer feed duct to present a respective baffle formed in the body of the ignition torch. It is assumed herein that a duct presents a baffle whenever the duct presents at least one bend in a plane containing the center of the combustion chamber, which bend (or change of direction, relative to the fluid flow direction) is through an angle that is greater than 90°, and preferably greater than 120°.

Alternatively, or in addition, provision may be made for the fuel feed duct and/or the oxidizer feed duct and/or the oxidizer rejection duct to include a thermal shock absorber portion. The term “thermal shock absorber portion” is used herein to mean a portion of duct that extends in the wall of the body of the torch in a direction that is at an angle of more than 45° relative to a radial direction with reference to a center of the combustion chamber. The fluid thus flows in the thermal shock absorber portion in a direction that is at an angle of more than 45° relative to the radial direction: it thus flows without directly approaching the combustion chamber. This flow enables it to exchange heat with the body of the torch and thus to cool it.

In an embodiment, the fuel feed duct and/or the oxidizer feed duct occupy(ies) a solid angle that is large (e.g. not less than 2 steradians), relative to a center of the combustion chamber.

Specifically, in order to enhance heat exchange, the body of the torch is designed in such a manner that the heat exchange area is maximized, while nevertheless taking care that the thicknesses of metal are sufficient to provide the torch with its mechanical strength.

### Fastening

It is also generally preferable to avoid the rather high temperature of the ignition torch being communicated to other portions of the rocket engine.

Thus, in an embodiment, the body presents a fastener flange arranged around the ejection tube. The temperature of the ignition torch may possibly be lower than that of the body.

In order to avoid the temperature of the flange rising, the ignition torch may further include a thermal insulation passage arranged radially between an internal duct of the ejection tube and the flange, and in fluid flow isolation from the oxidizer reinjection duct (i.e. without any possibility of exchanging fluid therewith). The chamber is preferably in communication with the atmosphere outside the ignition torch. It may form part of the body itself, or part of the ejection tube, or it may be arranged at least in part between them.

### BRIEF DESCRIPTION OF THE DRAWINGS

The invention can be well understood and its advantages appear better on reading the following detailed description of embodiments given as non-limiting examples. The description refers to the accompanying drawings, in which:

FIG. 1 is a diagrammatic section view of a rocket engine fitted with an ignition torch in a first embodiment of the invention;

FIG. 2 is a diagrammatic perspective view of the FIG. 1 ignition torch;

FIG. 3 is a diagrammatic section view of the FIG. 1 ignition torch;

FIG. 3A is a detail view taken from FIG. 3; and

FIG. 4 is a diagrammatic section view of an ignition torch in a second embodiment of the invention.

### DETAILED DESCRIPTION OF THE INVENTION

In the figures, elements that are similar or identical are given the same numerical references.

### First Embodiment

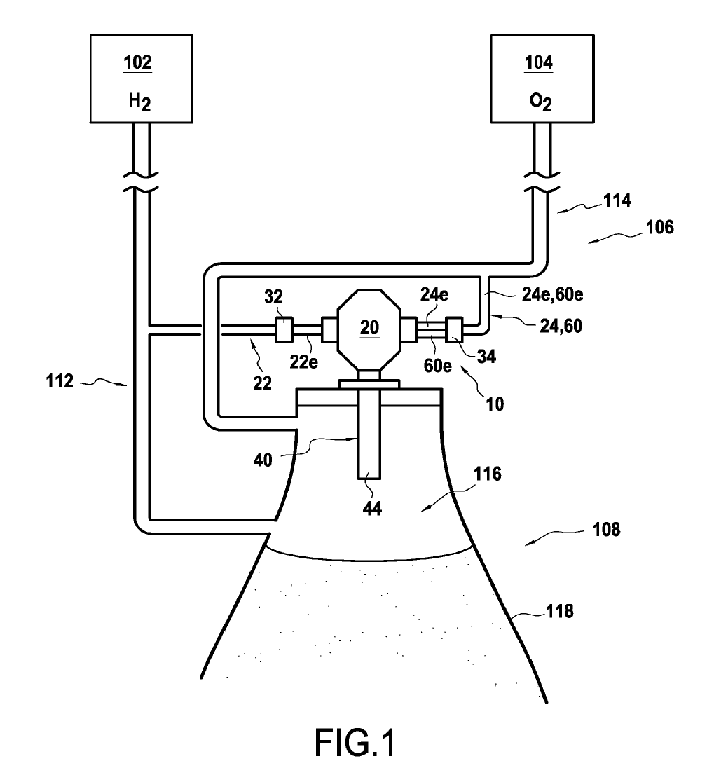

With reference to FIG. 1, there follows a description of a rocket engine 100 fitted with an ignition torch 10 of the invention.

The rocket engine 100 is mainly constituted by a nozzle 108 containing its main combustion chamber 116 (rocket engine combustion chamber).

It also includes a feed circuit 106 enabling it to be fed from two propellant tanks 102 and 104, and other pieces of equipment that are not described.

The two tanks 102 and 104 are respectively a liquid hydrogen tank 102 and a liquid oxygen tank 104. Thus hydrogen is the fuel and oxygen is the oxidizer. Naturally, although the description below refers to hydrogen as the fuel and oxygen as the oxidizer, the invention can be performed using any other suitable fuel-and-oxidizer pair; thus, in the description below, the terms “hydrogen” and “oxygen” should be understood as being replaceable respectively by the terms “fuel” and “oxidizer” in the meaning of the invention.

The nozzle 108 mainly comprises the main combustion chamber 116 situated in its top portion, and a diverging portion 118. The ignition torch 10 is fastened to the top of the nozzle 108, in order to launch combustion of the propellants in the combustion chamber 116, and thus start the engine 100.

(Positions referred to as “top” or “bottom” refer to the usual position of the engine during storage, and as shown in the figures, which does not necessarily correspond to the orientation of the engine in use.)

The feed circuit 106 serves to feed the main combustion chamber 116 of the engine 100 with fuel and oxidizer.

For that purpose, it has a hydrogen circuit 112 and an oxygen circuit 114, fitted with not shown pumps, respectively for passing hydrogen and oxygen from the corresponding tanks to the combustion chamber 116, in known manner.

The torch 10 comprises a body 20 and an ejection tube 40. It is arranged in such a manner that the end of the ejection tube 40 is located in the combustion chamber 116; the flame produced by the torch 10 thus enables combustion of the propellants to be initiated in the combustion chamber 116, thereby starting the rocket engine 100.

The body 20 contains an internal combustion chamber 21 (torch combustion chamber) of small dimensions, which is connected by ducts 22 and 24 respectively to the hydrogen circuit 112 and to the oxygen circuit 114.

The flow rates of hydrogen and oxygen in the ducts 22 and 24 are regulated respectively by regulator valves 32 and 34 that are controlled by an electronic control unit 50.

The ignition torch 10 also has an oxygen reinjection duct 60 that is arranged in a manner described in greater detail below. The flow rate in this duct is also regulated by the regulator valve 34.

The ignition torch 10 operates as follows.

The torch serves to ignite the engine 100, i.e. to initiate combustion of the hydrogen and oxygen that are injected into the combustion chamber 116.

This combustion is initiated by the gas discharged by the torch 10 into the chamber 116. The temperature of this gas is very high in order to ignite the propellants in the chamber 116.

This temperature constitutes one of the conditions imposed for the gas produced by the torch for injection into the chamber. These conditions are determined to ensure combustion that is as complete as possible in the combustion chamber, which combustion usually takes place in a main chamber of a rocket engine at a temperature of the order of 2400 K to 3000 K. To achieve this target, the temperature of the injected gas is generally greater than or even much greater than 1000 K.

The gas discharged by the torch 10 is produced by the combustion of hydrogen in oxygen inside the internal combustion chamber 21: hydrogen and oxygen are injected simultaneously into the chamber 21 (via the ducts 22 and 24); they are ignited by sparks produced by a spark plug 37 provided in the chamber 21.

Their combustion produces water vapor at high temperature. The gas that is produced thus comprises a mixture of water vapor and residual hydrogen or oxygen, depending on the hydrogen/oxygen ratio introduced into the torch.

In addition, the oxygen reinjection duct enables additional oxygen to be supplied at the outlet of the ejection tube 40 (or in its vicinity).

The overall mixture ratio from the torch 10 is thus determined not only by the quantities of hydrogen and oxygen introduced into the chamber 21, but also by the quantity of oxygen injected by the oxygen reinjection duct 60.

The mixture ratio of the torch 10 can thus be modulated or controlled by suitably controlling the fluid flow rates in the ducts 22, 24, and 60 using the valves 32 and 34. (The valve 34 serves to control the flow rate in both of the ducts 24 and 60; it would also be possible to provide two distinct valves.)

The engine 100 is controlled by the electronic control unit 50. This unit serves in particular to control the mixture ratio in the torch 10 continuously by regulating or controlling the opening of the valves 32 and 34.

The end of the ejection tube 40 is placed at a distance d from the walls of the combustion chamber 116. This distance is selected as being sufficient enough to ensure that even though the temperature of the flame produced by the torch is extremely high, the temperature reached by the walls of the chamber 116 remains considerably lower.

In the example shown, the distance d between the end of the tube 40 and the wall of the chamber 116 is thus greater than three times the inside diameter of the tube 40 (FIG. 1).

The electronic control unit 50 is configured to regulate the torch relative to a normalized mixture ratio that may lie in the range 0.1 to 10. As a result, the torch can be used to initiate combustion in the chamber 116 under a very wide variety of conditions; consequently, the rocket engine is suitable for performing a very wide variety of missions.

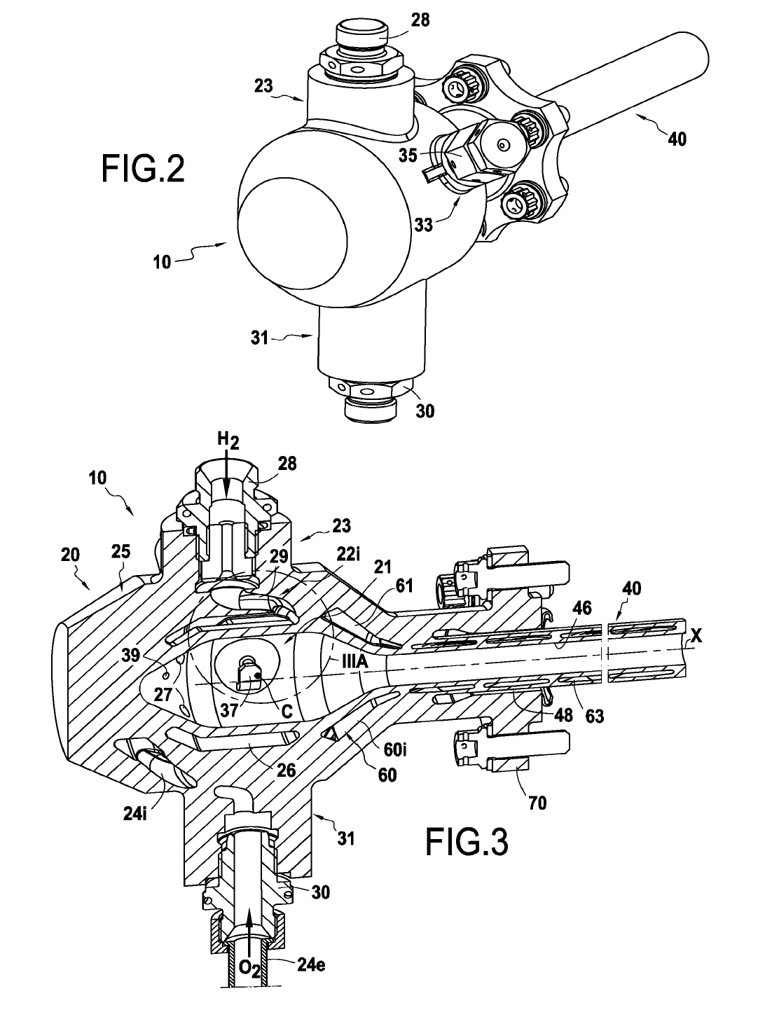

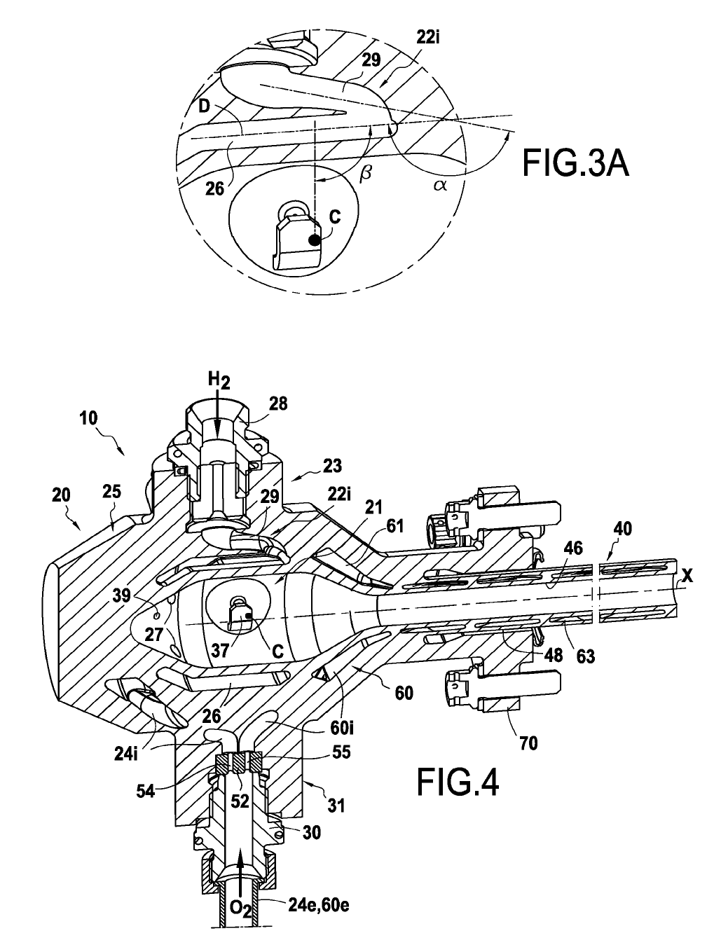

The internal structure of the ignition torch 10 is described below with reference to FIGS. 2, 3, and 3A.

The body 20 is fabricated additively by sintering metal powders.

Its central portion is occupied by the combustion chamber 21. This chamber is in the shape of a shuttle or an elongate ellipsoid, being substantially a volume of revolution about the axis X of the ejection tube 40, which is arranged to extend the chamber 21.

The body 20 is thus in the form of a thick-walled enclosure 25 formed around the combustion chamber 21. It presents three projecting portions 23, 31, and 33 that have external connections 28, 30, and 35 fastened therein in order to pass respectively the fuel (hydrogen) and oxidizer (oxygen) feed ducts 22 and 24, and the oxygen reinjection duct 60.

Thus, each of the ducts 22, 24, and 60 is made up of a plurality of portions:

a pipe portion 22e, 24e, 60e connecting the appropriate feed circuit 112, 114 to the body 20 via a regulator valve 32 or 34;

a respective external coupling portion 28, 30, or 35; and

an internal duct portion 22i, 24i, 60i located in the thickness of the wall of the body 20 and/or of the tube 40.

The feed ducts 22i and 24i internal to the body 20 thus serve to convey hydrogen and oxygen from the external couplings 28 and 30 to the combustion chamber 21.

The oxygen reinjection duct 60 is connected upstream to the oxygen feed circuit 114. Upstream from the valve 34, it has a pipe portion in common with the duct 24 (referenced 24, 60). Downstream from the valve, it comprises a pipe portion connected to the coupling 35. It thus has an internal portion 60i (also referred to as an internal pipe 60i) going from the coupling 35 to the outlet of the tube 40 through which it thus serves to inject oxygen for giving rise to second combustion.

The combustion chamber 21 enables combustion of hydrogen in oxygen; this combustion is initiated by a spark plug or by any other initiation or energy-delivery system 37 arranged in the combustion chamber.

The combustion produces combustion gas, which gas is discharged from the combustion chamber 21 via the ejection tube 40. That said, the combustion of hydrogen in oxygen takes place not only inside the combustion chamber, but also in the ejection tube 40 and outside it inside the combustion chamber 116.

The tube 40 has two ends: a first end whereby it is connected to the body 20; and a second end or outlet 44 that is placed inside the main combustion chamber 116 of the rocket engine.

The tube 40 presents an internal duct 46 that goes from the combustion chamber 21 and opens out into the main combustion chamber 116.

In order to reduce mechanical stresses in the body 20 as may be caused by very great temperature differences between the propellants (hydrogen, oxygen) which are or may be extremely cold, and the combustion gas which on the contrary is hot, the following provisions are adopted.

Firstly, the wall 25 of the body is particularly thick; the internal ducts 22i and 24i for feeding hydrogen and oxygen do not inject hydrogen or oxygen directly into the combustion chamber 21, but on the contrary present baffles in the thickness of the wall 25 so that the fluids they are transporting are heated to some extent prior to being injected into the chamber 21. This serves to reduce the temperature of the wall 25.

### Internal Duct 22i for Feeding Hydrogen

In order to encourage heat exchange between the hydrogen and the body 20 of the torch (FIGS. 3 and 3A), the internal duct 22i for feeding hydrogen presents a cylindrical intermediate chamber 26 that surrounds the combustion chamber 21 (at least in a view looking along the axis of the tube 40).

This cylindrical chamber forms a thermal shock absorber portion. Specifically, in this chamber hydrogen flows in a direction D that, in the section plane, is parallel to the axis X of the ejection tube: this direction D forms an angle β relative to the radial direction (with respect to the center C of the combustion chamber); the angle β is 90°, and thus considerably greater than 45°.

In the intermediate chamber 26, the hydrogen thus flows inside the wall 25 without approaching the combustion chamber 21; this enables a large amount of heat exchange to take place between the hydrogen and the body 20 and also ensures that the temperature of the body 20 does not rise in unacceptable manner.

Upstream, the intermediate chamber 26 is connected to the coupling 28 via a connection segment 29. Downstream, the intermediate chamber 26 is connected to the combustion chamber 21 via injection holes 27.

As can be seen in FIG. 3A (detail taken from the axial section of FIG. 3), the hydrogen feed duct 22 presents, in the section plane containing the center C of the combustion chamber 21, at least one bend of angle α greater than 120°.

Thus, in this embodiment, the hydrogen feed duct 22 includes a baffle; the fuel (hydrogen) is thus constrained to flow within the wall 25 of the body 20 over a certain distance, thereby encouraging heat exchange between the hydrogen and the body 20 and thus enabling the body 20 to be maintained at a temperature that is sufficiently low.

### Internal Duct 24i for Feeding Oxygen

The internal duct 24i connects the coupling 30 to oxygen injection holes 39 formed in the wall of the combustion chamber 21.

### Duct 60 for Reinjecting Oxygen

The internal duct 60i is arranged firstly in the thickness of the body 20, and then further downstream in the thickness of the ejection tube 40.

Like the duct 22i, the duct 60i has a thermal shock absorber portion constituted by an intermediate chamber 61. This chamber forms a volume of revolution about the axis X and it is arranged at the end of the chamber 21 that is situated beside the ejection tube 40. The duct 60i connects the chamber 61 to the coupling 35 via a duct portion that is not shown.

Downstream from the chamber 61, the duct 60i is arranged inside the wall of the tube 40. In this portion, the duct 60i forms a helix 63 having a plurality of turns around the tube 40, thereby maximizing heat exchange between the tube 40 and the oxygen.

At the end of the tube 40, the duct 60i opens out into the combustion chamber 116 of the engine 100. It thus discharges oxygen substantially at the point where the hot gas is discharged by the ejection tube 40.

### Fastening

The ignition torch 10 also has a fastener flange 70 arranged around the tube 40 for fastening to the nozzle 108.

For this purpose, the wall of the tube 40 is very thick between the body 20 and the flange 70; it thus presents sufficient mechanical strength to transmit the weight of the body 20 to the flange 70.

Advantage is taken of this thickness to insulate the tube 40 thermally from the flange so as to avoid the temperature of the flange rising.

Specifically, the tube 40 presents a thermal insulation passage 48. This passage is arranged radially between the internal duct 46 of the tube 40 and the flange 70.

It also extends axially (along the axis X) from upstream to downstream relative to the plane where the flange 70 is fastened to the tube 40.

The passage 48 is isolated from the fluids (combustion gas and oxygen) flowing respectively in the ducts 46 and 60; it is in communication only with the atmosphere around the torch 10.

In the embodiment shown, the passage 48 communicates with the atmosphere situated at the end of the body 20 that is remote from the flange 70. In another embodiment, the passage (or chamber) 48 could communicate with the atmosphere situated on the same side as the body 20 with respect to the flange 70.

### Second Embodiment

A second embodiment of the ignition torch 10 is described below with reference to FIG. 4. This second embodiment is identical to the first embodiment, except for certain characteristics that are specified below.

The difference between the first and second embodiments lies in the way in which oxygen and hydrogen are regulated.

In the first embodiment, the valves 32 and 34 serve respectively to regulate the flow rate of hydrogen and oxygen in the ducts 22, 24, and 60.

In contrast, in the second embodiment, these three flow rates are not regulated by regulator valves, but they are controlled merely by using plates having calibrated flow sections.

In the embodiment shown, in order to simplify fabrication, the body 20 does not have a projection 33 and thus does not have an external coupling 35.

In this embodiment, going from the coupling 30, a single pipe 24e, 60e constitutes the external portion of the duct 24 and of the duct 60. This pipe connects the coupling 30 directly to the circuit 114; there is no regulator valve 34.

Likewise, another pipe forms the duct 22e and connects the coupling 28 directly to the circuit 112; likewise there is no regulator valve 32.

The internal duct 24i and the internal duct 60i are both connected upstream to a calibrated plate 52 arranged between the coupling 30 and connected to the duct 24e, 60e by the coupling.

The calibrated plate 52 is a plate in the form of a disk with two calibrated orifices 54 and 55. The calibrated orifices 54 and 55 constitute constrictions that control the fluid flow rate respectively in the ducts 24i and 60i.

Advantageously, the plate 52 is removable. After unscrewing the coupling 30, it is easy to remove the plate in order to replace it with another plate.

By way of example, it is possible to replace a plate 52 with another plate 52′ having calibrated orifices 54′ and 55′ that present flow sections that are different from those of the orifices 54 and 55: such a change then makes it simple to modify the mixture ratio of the torch 10 and thus the way in which the tube 40 is cooled.

Although the present invention is described with reference to specific embodiments, it is clear that various modifications and changes may be undertaken on these embodiments without going beyond the general ambit of the invention as defined by the claims. In addition, individual characteristics of the various embodiments mentioned may be combined in additional embodiments. Consequently, the description and the drawings should be considered in a sense that is illustrative rather than restrictive.

1. A rocket engine comprising a rocket engine combustion chamber and an ignition torch for initiating combustion in the rocket engine combustion chamber;
the rocket engine combustion chamber being a main combustion chamber of the rocket engine, or a combustion chamber of a gas generator of the rocket engine, or a combustion chamber of a preburner of the rocket engine; wherein
the ignition torch comprises:
a body in which a torch combustion chamber is arranged; and
an ejection tube for discharging the combustion gas leaving the torch combustion chamber;
the ejection tube has a first end whereby it is connected to the body and a second end arranged in the rocket engine combustion chamber;
the body is configured to allow the torch combustion chamber to be fed with fuel and oxidizer respectively via a fuel feed duct and an oxidizer feed duct; and
the ignition torch further comprises an oxygen reinjection duct configured to enable oxygen to be injected substantially at the outlet of the ejection tube.

2. A rocket engine according to claim 1, further including a fuel feed regulator valve and/or an oxidizer feed regulator valve for feeding the combustion chamber and/or an oxidizer reinjection regulator valve, which valve(s) is/are adapted to regulate respectively fuel feed to the torch combustion chamber, oxidizer feed to the torch combustion chamber, and/or an oxidizer injection flow into the oxidizer reinjection duct.

3. A rocket engine according to claim 1, further comprising a fuel feed plate of calibrated flow section arranged in the fuel feed duct, and/or an oxidizer feed plate of calibrated flow section arranged in the oxidizer feed duct, and/or an oxidizer reinjection plate of calibrated section arranged in the oxidizer reinjection duct.

4. A rocket engine according to claim 3, wherein said plate or at least one of said plates is removable.

5. A rocket engine according to claim 3, wherein the oxidizer feed plate and the oxidizer reinjection plate form a single plate.

6. A rocket engine according to claim 1, wherein the oxidizer reinjection duct is arranged at least in part in the thickness of a wall of the ejection tube.

7. A rocket engine according to claim 1, wherein the fuel feed duct and/or the oxidizer feed duct present(s) a respective baffle formed in the body of the ignition torch.

8. A rocket engine according to claim 1, wherein the fuel feed duct and/or the oxidizer feed duct, and/or the oxidizer rejection duct include(s) a respective thermal shock absorber portion extending within the wall of the body of the torch in a direction that makes an angle greater than 45° relative to a radial direction with respect to a center of the torch combustion chamber.

9. A rocket engine according to claim 1, presenting a fastener flange arranged around the ejection tube, and a thermal insulation passage arranged radially between an internal duct of the ejection tube and the flange, and in fluid flow isolation from the oxidizer reinjection duct.

10. A rocket engine according to claim 1, characterized in that it is configured so that the ignition torch can operate with a normalized mixture ratio greater than 5.

11. A rocket engine according to claim 1, wherein a minimum distance between each wall of the rocket engine combustion chamber and the second end of the ejection tube is greater than kD, where D is the inside diameter at the outlet of the ejection tube, and k is a coefficient equal to 3.
